(19) United States
(12) Patent Application Publication
(10) Pub. No.: US 2025/0053778 A1
(43) Pub. Date: Feb. 13, 2025

(54) METHODS AND PROCESSORS FOR TRAINING A NEURAL NETWORK

(71) Applicant: HUAWEI TECHNOLOGIES CO., LTD., Shenzhen (CN)

(72) Inventors: Mojtaba VALIPOUR, Waterloo (CA); Mehdi REZAGHOLIZADEH, Concord (CA); Marziehsadat TAHAEI, Richmond Hill (CA); Ivan KOBYZEV, Montreal (CA); Ali GHODSI, Kanata (CA); Boxing CHEN, Ottawa (CA)

(21) Appl. No.: 18/446,170

(22) Filed: Aug. 8, 2023

(51) Int. Cl. G06N 3/045; G06N 3/047

(52) U.S. Cl. CPC G06N 3/045; G06N 3/047

(57) ABSTRACT

Methods and processors for using a Neural Network (NN) are disclosed. The method includes, during a first iteration, determining a first sub-network of the NN and training the first sub-network. The method includes during a second iteration a second sub-network of the NN and training the second sub-network. The method includes during an inference iteration of the NN, selecting a target sub-network amongst the first sub-network and the second sub-network, and generating an inference output by employing only the target sub-network of the NN on inference data for reducing computational resources of the processor for generating the inference output.

### FIELD

The present technology relates generally to neural networks; and in particular, to methods and processors for training neural networks.

### BACKGROUND

Deep Neural Networks (DNNs) are a class of artificial NNs that are designed to mimic the structure and function of the human brain. They are a subset of machine learning models used for various tasks, including image and speech recognition, natural language processing, and reinforcement learning.

DNNs consist of multiple layers of interconnected nodes (neurons), each layer processing and transforming the input data before passing it to the next layer. The input layer receives raw data, such as images or text, for example, and subsequent hidden layers gradually extract relevant features and patterns from the input. The final output layer produces the desired prediction or classification.

The term “deep” in DNN refers to the depth of the network, indicating the presence of many hidden layers between the input and output layers. The depth allows DNNs to learn complex representations from data, making them suitable for handling large-scale and high-dimensional tasks.

Training a DNN involves an iterative process, such as backpropagation, for example, where the network's parameters (weights and biases) are adjusted to minimize the difference between the predicted output and the actual target. This process relies on labeled training data, and the network gradually improves its performance as it iteratively learns from the data.

DNNs require considerable computational resources during the training phase and the inference phase. In many cases, however, the computational budget for a given application may be changed over time and/or may be reduced due to other computational demands.

### SUMMARY

Developers have devised methods and devices for overcoming at least some drawbacks present in prior art solutions.

Pre-trained language models can be used for improving the performance of downstream tasks such as language understanding, machine translation, entity recognition, semantic modelling and reasoning, conversational AI, etc. However, pre-trained language models may be large and computationally expensive for a processor during the training and inference phases.

For example, student-teacher frameworks can be used for reducing the size/complexity of a given model, but such frameworks require additional computational resources during training and/or may result in a comparatively lower performance to the main pre-trained language model.

In some embodiments, there is provided methods and processors for training a Neural Network (NN) model with a nested architecture. Broadly, a NN model with a nested architecture comprises comparatively smaller “sub-models” or “sub-networks” that are at least one of shallower and/or narrower than the NN model itself. Training the NN model in accordance with at least some embodiments of the present technology may result in training a plurality of sub-models that can be sorted by at least one of accuracy, latency, and layer importance. During training, at a given training iteration, a loss for all or at least some sub-models can be minimized through a back-propagation technique, for example.

Developers of the present technology have also devised a scalable methodology for combining sampling (e.g., random) of sub-models with gradient accumulation in order to further reduce the computational cost of the training phase for obtaining the trained NN model and a plurality of NN sub-models. In other words, one single training phase may be used to yield multiple sub-models with different capacities.

Broadly, a capacity of a NN model and/or sub-model refers to its ability to learn and represent complex patterns and relationships in the data it is trained on. In other words, a capacity parameter measures the flexibility and expressiveness of the NN model and/or sub-model in approximating functions.

Developers of the present technology have realized that so training a single model and yielding a plurality of sub-models therefrom can resolve several challenges for practical deployment scenarios while optimizing computational resources of a processor during training. but also during inference phases.

In a publication entitled “Deebert: Dynamic early exiting for accelerating bert inference”, authored by Xin et al., and published in 2020, there is provided a technique that adds a classifier to intermediate layers of an already trained NN. While the parameters of the main model are frozen, the parameters of the classifiers can be updated in a separate fine-tuning process. Respective classifiers and their subsequent network can be used as an independent sub-model. Developers have realized that the performance of the sub-models produced using this technique significantly drops in comparison to the main model.

In a publication entitled “Reducing transformer depth on demand with structured dropout”, authored by Fan et al., and published in 2019, there is provided a technique where layers of the model can be dropped during training with a certain probability (drop rate). At the inference time, the number of layers that is supported depends mostly on the drop-rate and therefore need further re-training for different drop rates. Moreover, layer-drop techniques require specific search patterns for dropping layers at the inference time and training time.

Developers of the present technology have realized that conventional training of a NN model does not allow for sub-model extraction at the inference phase, since sub-models extracted from a conventionally trained model will have a comparatively lower performance to the whole NN model.

Developers have devised a training method that allows for post-training sub-model extraction by enforcing importance sorting of network modules within the main NN model. As a result, the training methods described herein lead to a reduction of computational cost required for performing separate training for each sub-model. Some training methods described herein may allow reducing the performance drop of the main model compared to normal training. Some training methods described herein may result in a low computational cost for sub-model extraction. In other words, NN modules can be sorted by importance, and a best sub-model for a given computational budget can be selected.

The training methods described herein may allow an easier switching between sub-models for a given task and reduce storage requirements for storing the sub-models since each smaller sub-model is a subset of a larger one within the nested architecture.

In a first broad aspect of the present technology, there is provided a method of using a Neural Network (NN), the NN comprising an input layer, an output layer, and a plurality of intermediate layers. The method is executable by at least one processor and comprises, during a first training iteration of the NN, determining a first continuous sequence of intermediate layers from the plurality of intermediate layers of the NN, the input layer, the first continuous sequence of intermediate layers, and the output layer forming a first sub-network of the NN, and training the first sub-network based on training data. During a second training iteration of the NN, the method further includes determining a second continuous sequence of intermediate layers from the plurality of intermediate layers of the NN, the input layer, the second continuous sequence of intermediate layers, and the output layer forming a second sub-network of the NN. The second continuous sequence of intermediate layers is different from the first sequence of continuous layers, the second continuous sequence of intermediate layers at least partially overlapping the first sequence of continuous layers. The method further includes training the second sub-network based on the training data. The method further includes, during an inference iteration of the NN, selecting a target sub-network amongst the first sub-network and the second sub-network. The method further includes generating an inference output by employing only the target sub-network of the NN on inference data for reducing computational resources of the at least one processor for generating the inference output.

In some non-limiting implementations, the method further includes, during the first training iteration, determining a first depth index indicative of a first depth of the first continuous sequence of intermediate layers in the NN. The determining the first continuous sequence of intermediate layers includes determining a continuous sequence of intermediate layers that is most adjacent to the input layer of the NN and which includes a total number of layers equal to the first depth index. The method further includes, during the second training iteration, determining a second depth index indicative of a second depth of the second continuous sequence of intermediate layers in the NN, the second depth index being different from the first depth index. The determining the second continuous sequence of intermediate layers includes determining an other continuous sequence of intermediate layers that is most adjacent to the input layer of the NN and which includes a total number of layers equal to the second depth index.

In some non-limiting implementations, the determining the first depth index includes randomly determining the first depth index from an interval of depth indexes, and the determining the second depth index includes randomly determining the second depth index from the interval of depth indexes, the interval of depth indexes having been pre-determined based on a depth of the NN.

In some non-limiting implementations, the method further includes, during the first training iteration, determining a first width index for the first continuous sequence of intermediate layers indicative a first partial width of the first continuous sequence of intermediate layers to be trained during the first training iteration. The training of the first sub-network includes training only the first partial width of the first continuous sequence of intermediate layers based on the training data. The method further includes and, during the second training iteration, determining a second width index for the second continuous sequence of intermediate layers indicative a second partial width of the second continuous sequence of intermediate layers to be trained during the second training iteration, the second width index being different from the first width index. The training of the second sub-network includes training only the second partial width of the second continuous sequence of intermediate layers based on the training data.

In some non-limiting implementations, the determining the first width index includes randomly determining the first width index from an interval of width indexes, and the determining the second width index includes randomly determining the second width index from the interval of width indexes, the interval of width indexes having been pre-determined based on a width of the plurality of intermediate layers of the NN.

In some non-limiting implementations, the selecting the target sub-network comprises comparing at least one of a first accuracy parameter of the first sub-network and a second accuracy parameter of the second sub-network, a first latency parameter of the first sub-network and a second latency parameter of the second sub-network, and a first importance parameter of the first sub-network and a second importance parameter of the second sub-network.

In some non-limiting implementations, the plurality of intermediate layers is a plurality of architectural blocks of the NN, a given one of the plurality of architectural blocks including a sub-set of intermediate layers for generating an output of the given one of the plurality of architectural blocks.

In some non-limiting implementations, the plurality of architectural blocks include at least one of a convolutional block with at least one convolutional layer, a pooling block with at least one pooling layer, a fully connected block with at least one fully-connected layer, a residual block with at least one skip connection, a batch normalization block with at least one batch normalization layer, a recurrent block with at least one recurrence mechanism, an attention block with at least one self-attention mechanism and an activation block with at least one activation layer.

In some non-limiting implementations, the output layer is at least two output layers, and wherein the output layer of the first sub-network is a first one from the at least two output layers, and the output layer of the second sub-network is a second one from the at least two output layers, the first and second one of the at least two output layers being different output layers.

In a first broad aspect of the present technology, there is provided a system for using a Neural Network (NN), the NN comprising an input layer, an output layer, and a plurality of intermediate layers. The system includes a controller and a memory storing a plurality of executable instructions which, when executed by the controller, cause the system to, during a first training iteration of the NN, determine a first continuous sequence of intermediate layers from the plurality of intermediate layers of the NN, the input layer, the first continuous sequence of intermediate layers, and the output layer forming a first sub-network of the NN. The system is further configured to train the first sub-network based on training data. During a second training iteration of the NN, the system is further configured to determine a second continuous sequence of intermediate layers from the plurality of intermediate layers of the NN, the input layer, the second continuous sequence of intermediate layers, and the output layer forming a second sub-network of the NN, the second continuous sequence of intermediate layers being different from the first sequence of continuous layers, the second continuous sequence of intermediate layers at least partially overlapping the first sequence of continuous layers. The system is further configured to train the second sub-network based on the training data. During an inference iteration of the NN, the system is further configured to select a target sub-network amongst the first sub-network and the second sub-network and generate an inference output by employing only the target sub-network of the NN on inference data for reducing computational resources of the at least one processor for generating the inference output.

In some non-limiting implementations, the system is further configured to, during the first training iteration, determine a first depth index indicative of a first depth of the first continuous sequence of intermediate layers in the NN, the determining the first continuous sequence of intermediate layers includes determining a continuous sequence of intermediate layers that is most adjacent to the input layer of the NN and which includes a total number of layers equal to the first depth index. The system is further configured to, during the second training iteration, determine a second depth index indicative of a second depth of the second continuous sequence of intermediate layers in the NN, the second depth index being different from the first depth index. The determining the second continuous sequence of intermediate layers includes determining an other continuous sequence of intermediate layers that is most adjacent to the input layer of the NN and which includes a total number of layers equal to the second depth index.

In some non-limiting implementations, the determining the first depth index includes randomly determining the first depth index from an interval of depth indexes, and the determining the second depth index includes randomly determining the second depth index from the interval of depth indexes, the interval of depth indexes having been pre-determined based on a depth of the NN.

In some non-limiting implementations, the system is further configured to, during the first training iteration, determine a first width index for the first continuous sequence of intermediate layers indicative a first partial width of the first continuous sequence of intermediate layers to be trained during the first training iteration. The training the first sub-network includes training only the first partial width of the first continuous sequence of intermediate layers based on the training data. The system is further configured to, during the second training iteration, determine a second width index for the second continuous sequence of intermediate layers indicative a second partial width of the second continuous sequence of intermediate layers to be trained during the second training iteration, the second width index being different from the first width index. The training of the second sub-network including training only the second partial width of the second continuous sequence of intermediate layers based on the training data.

In some non-limiting implementations, the determining the first width index includes randomly determining the first width index from an interval of width indexes, and the determining the second width index includes randomly determining the second width index from the interval of width indexes, the interval of width indexes having been pre-determined based on a width of the plurality of intermediate layers of the NN.

In some non-limiting implementations, the system is configured to, upon selecting the target sub-network, compare at least one of a first accuracy parameter of the first sub-network and a second accuracy parameter of the second sub-network, a first latency parameter of the first sub-network and a second latency parameter of the second sub-network, and a first importance parameter of the first sub-network and a second importance parameter of the second sub-network.

In some non-limiting implementations, the plurality of intermediate layers is a plurality of architectural blocks of the NN, a given one of the plurality of architectural blocks including a sub-set of intermediate layers for generating an output of the given one of the plurality of architectural blocks.

In some non-limiting implementations, the plurality of architectural blocks include at least one of a convolutional block with at least one convolutional layer, a pooling block with at least one pooling layer, a fully connected block with at least one fully-connected layer, a residual block with at least one skip connection, a batch normalization block with at least one batch normalization layer, a recurrent block with at least one recurrence mechanism, an attention block with at least one self-attention mechanism and an activation block with at least one activation layer.

In some non-limiting implementations, the output layer is at least two output layers, and wherein the output layer of the first sub-network is a first one from the at least two output layers, and the output layer of the second sub-network is a second one from the at least two output layers, the first and second one of the at least two output layers being different output layers.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein.

FIG. 2 is a schematic illustration of a Neural Network (NN) model, a plurality of sub-models in the NN model, and a nested configuration of the plurality of sub-models in the NN model.

FIG. 3 is a schematic illustration of a number of depth-wise training iterations of a NN model, in accordance with at least some embodiments of the present technology.

FIG. 4 is a schematic illustration of a number of depth-wise and width-wise training iterations of a NN model, in accordance with at least some embodiments of the present technology.

FIG. 5 is a scheme-block illustration of a method executed by a processor of the computing device of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

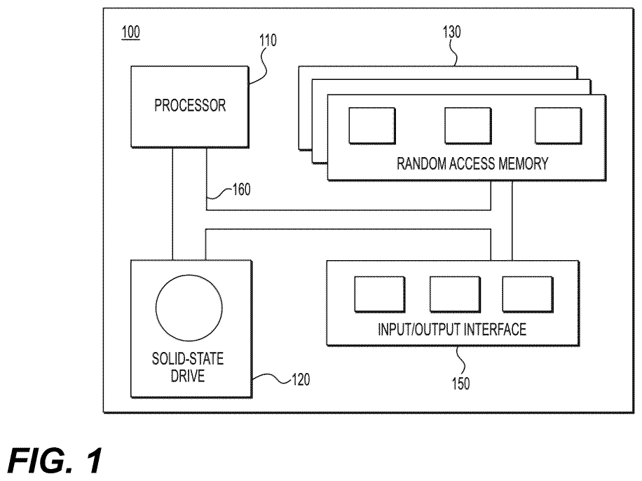

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (SaaS). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

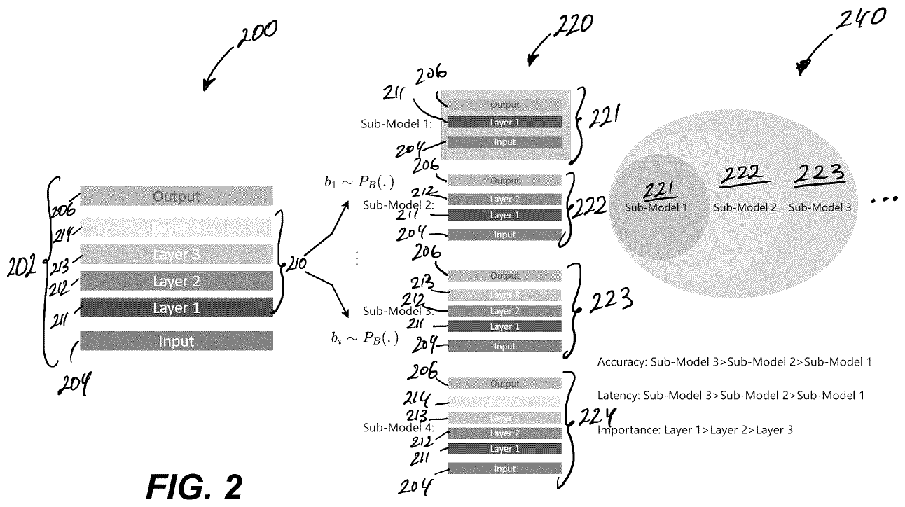

With reference to FIG. 2, there is depicted a model 200 executable by the electronic device of FIG. 1. The model 200 may be implemented as a Neural Network (NN). Broadly, NNs are a class of machine learning models inspired by the human brain's neural structure. They consist of interconnected layers of artificial neurons, each processing and transmitting information to make predictions or decisions based on input data. NNs are capable of learning complex patterns and representations, making them widely used in various tasks such as image recognition, natural language processing, and speech recognition, for example. The key components of NNs are input layers, hidden layers (where most of the processing occurs), and an output layer that provides the final predictions or classifications.

Developers have realized that the model 200 may have an architecture classifiable into at least one of a plurality of classes of NNs. A first class of NNs includes Convolutional NNs (CNNs). Broadly, CNNs are often used for image recognition and computer vision tasks. They use convolutional layers to automatically detect meaningful features in images, such as edges, textures, and shapes. CNNs are also used for solving tasks like image classification, object detection, and image generation. A second class of NNs includes Recurrent Neural Networks (RNNs). Broadly, RNNs are used for processing sequential data and possess “loops” that allow information to persist. They are well-suited for tasks involving time-series data, natural language processing, and speech recognition. RNNs can handle variable-length inputs and capture dependencies across sequences. A third class of NNs includes Generative Adversarial Networks (GANs). Broadly, GANs consist of two NNs, a generator, and a discriminator, engaged in a game-like scenario. The generator generates synthetic data samples, and the discriminator evaluates whether the data is real or fake. GANs can be used for generating realistic images, audio, and text. A fourth class of NNs includes Transformer Networks. Broadly, transformers are designed for sequence-to-sequence tasks, like machine translation and language modeling. They rely on self-attention mechanisms to weigh the importance of different parts of the input sequence, enabling parallel processing and capturing long-range dependencies.

In some embodiments of the present technology, it can be said that a NN architecture may have a width parameter and a depth parameter.

Broadly, the width parameter of a NN refers to a number of neurons or units present in a respective layer of the network. The width parameter determines the capacity of the network to learn and represent complex patterns in the data. A higher width parameter corresponds to a larger number of neurons in each layer, allowing the network to capture more features and relationships within the data. For example, in a feedforward NN with three layers (input, hidden, and output), a width parameter of 128 neurons in the hidden layer implies that there are 128 units in that layer, and each of them performs computations on the input data.

Broadly, the depth parameter of a NN refers to the number of layers present in the network. It represents an overall depth or a number of stages through which data is processed before reaching the output layer. Deeper networks have more layers, which enables them to learn hierarchical and abstract representations of the data. A deeper network can capture complex patterns in data by learning multiple levels of abstractions. For example, a deep CNN for image classification might consist of several convolutional layers followed by pooling layers, and finally, fully connected layers. A depth parameter of 15 in this example implies that the network contains 15 layers in total excluding the input/output layers.

In summary, the width and depth parameters are architectural parameters of a NN that influence the network's capacity to learn complex representations and its overall performance on a given task. The width determines the number of neurons in each layer, while the depth signifies the number of layers in the network. Developers of the present technology have realized that both parameters may be selected and/or optimized to control model complexity and/or generalization.

Returning to the description of FIG. 2, the model 200 comprises a plurality of layers 202 including an input layer 204, and output layer 206, and a plurality of intermediate layers 210. The plurality of intermediate layers includes layers 211 to 214.

In some embodiments of the present technology, the processor 110 may be configured to determine a plurality of sub-models 220 based on the model 200. In some embodiments, it can be said that the processor 110 may be configured to identify sub-sets of layers within the model 200 in order to determine the plurality of sub-models 220.

In this example, the processor 110 may be configured to determine a first sub-model 221, a second sub-model 222, a third sub-model 223, and a fourth sub-model 224 based on the model 200. The first sub-model 221 comprises the input layer 204, the output layer 206, and the layer 211. The second sub-model 222 comprises the input layer 204, the output layer 206, and the layers 211 and 212. The third sub-model 223 comprises the input layer 204, the output layer 206, and the layers 211 to 213. The fourth sub-model 224 is the model 200 and comprises the input layer 204, the output layer 206, and the layers 211 to 214.

There is also depicted a graphical representation 240 showing a nesting configuration of the first sub-model 221, the second sub-model 22, and the third sub-model 223 with the model 200. Broadly speaking, it can be said that the plurality of sub-models 220 are nested sub-models because their respective intermedial layers are continuous and at least partially overlapping sequences of intermediate layers.

For example, the layers 211 to 213 of the third sub-model 223 represents a continuous sub-sequence of intermediate layers within the intermediate layers 210 of the model 200 (i.e., without any intermediate layer between 211 and 213 of the model 200 being dropped). In another example, the layers 211 and 212 of the second sub-model 222 represent a continues sequence of intermediate layers within the intermediate layers 210 of the model 200. The sequence of the layers 211 to 213 of the third sub-model 223 also partially overlaps with the sequence of the layers 211 to 212.

In some embodiments of the present technology, the processor 110 may select a given sub-model amongst the plurality of sub-models 220 to be used instead of the model 200 in variety of scenarios. For example, the processor 110 may be configured to selective use the given sub-model instead of the model 200 because the given sub-model requires comparatively lower computational resources for inference.

Developers of the present technology have also realized that availability of computational resources of the electronic device 100 may vary depending on a current resource demand for other processing tasks. In some embodiments, the processor 110 may be configured to monitor currently available computational resources. In response to currently available computational resources being below one or more thresholds, the processor 110 may be configured to select a given sub-model to be used at least temporarily instead of the model 200 for solving processing tasks. This may allow the processor 110 to continue solving the processing tasks when currently available computational resources are too scarce for running the model 200 and/or for freeing up and re-allocating additional computational resources for other processing tasks.

It should be noted that although the description herein further below will refer to intermediate layers of a NN, at least some aspects of the present technology may be applied to architectural blocks and/or sequences of architectural blocks of a given NN without departing from the scope of the present technology. Broadly, NN blocks are building units of a NN that can be combined to create more complex architectures. NN blocks can help in modularizing the network design, making it easier to construct and train deep learning models. Different blocks serve different purposes, such as feature extraction, non-linearity introduction, normalization, and regularization.

A first type of NN blocks include convolutional blocks. A convolutional block typically comprises one or more convolutional layers and potentially followed by activation functions like Rectified Linear Unit (ReLU). Convolutional layers perform feature extraction by applying filters or kernels to input data. These blocks are widely used in image-related tasks due to their ability to capture spatial patterns effectively. A second type of NN blocks includes pooling blocks. Pooling blocks comprise pooling layers (e.g., MaxPooling or AveragePooling) to downsample feature maps, reducing the spatial dimensions of the data while retaining important information. Pooling helps in reducing computational complexity and increasing translation invariance. A third type of NN blocks includes fully connected blocks. A fully connected block comprises one or more dense layers, where every neuron is connected to every neuron in the previous layer. These NN blocks are commonly used in traditional neural networks and can be found in the final layers for classification tasks. A fourth type of NN blocks includes residual blocks. Residual blocks, popularized by Residual Networks (ResNet), comprise skip connections to optimize training of deep networks. By adding the input directly to the output of a layer, these NN blocks mitigate the vanishing gradient problem and ease the learning process in deep architectures. A fifth type of NN blocks include batch normalization blocks. Batch normalization blocks add batch normalization layers to normalize the output of a layer with respect to the mini-batch statistics. It helps in improving the convergence of the network, reducing internal covariate shift, and acts as a form of regularization. A sixth type of NN blocks includes recurrent blocks. Recurrent blocks, such as LSTM (Long Short-Term Memory) and GRU (Gated Recurrent Unit), are used in handling sequential data. These NN blocks maintain a hidden state that allows the network to capture temporal dependencies and process variable-length sequences. A seventh type of NN blocks includes attention blocks. Attention blocks, commonly used in Transformer networks, comprise self-attention mechanisms to weigh the importance of different parts of the input sequence. These NN blocks are used for natural language processing tasks by capturing long-range dependencies. An eighth type of NN blocks includes activation blocks. Activation blocks introduce non-linearity to the network by using activation functions such as ReLU, Leaky ReLU, sigmoid, and tanh, each serving a specific purpose in different parts of the network.

How the model 200 and one or more from the plurality of sub-models 220 are trained in the context of the present technology will now be described in greater details.

### Depth-Wise Sorted Training

In some embodiments, during training, a last layer of a model (e.g. the classification layer) may be shared between all sub-models. Alternatively, separate classification layers may be used for each sub-model. At each step during the training, a random index is sampled:

$${b}_{i} ∼ {P}_{B} ( \cdot ) where 1 \leq {b}_{i} \leq L \qquad ( 1 )$$

where L is the maximum number of sub-models and P_{B} is a predefined distribution over the sample space of all sub-models.

In other embodiments, the processor 110 may be configured to sample an index in a non-random manner. Additionally, this can be even a trajectory-based learned procedure. The processor 110 may be configured to use one or more of the following functions (i.e., objectives) to update the parameters of the model during training:
a) only train the sub-model with bᵢ layers (hereinafter referred to as SM_{b}_{ᵢ}):

$${min}_{{θ}_{i}} ℒ {=}^{Δ} CE ( y , {SM}_{{b}_{i}} ( x ; {θ}_{i} ) ) \qquad ( 2 )$$

b) train the sub-models that are subset of SM_{b}_{ᵢ}—that is, from SM₁ to SM_{b}_{ᵢ}:

$${min}_{{U}_{i = 1}^{{b}_{i}} {θ}_{i}} ℒ {=}^{Δ} {\sum }_{i = 1}^{{b}_{i}} CE ( y , {SM}_{i} ( x ; {θ}_{i} ) ) \qquad ( 3 )$$

where CE is the objective function like Cross-Entropy, SMᵢ is the ith sub-model, θᵢ are the parameters of the ith model, and L is the ultimate loss function.

In these embodiments, the processor 110 may be configured to update parameters of one sub-model and/or of a subset of sub-models during a given training iteration.

Additionally or alternatively, the processor 110 may be configured to use the following objective to update the parameters of all sub-models of a given model during a given training iteration:

$${min}_{{U}_{i = 1}^{L} {θ}_{i}} ℒ {=}^{Δ} {\sum }_{i = 1}^{L} CE ( y , {SM}_{i} ( x ; {θ}_{i} ) ) \qquad ( 4 )$$

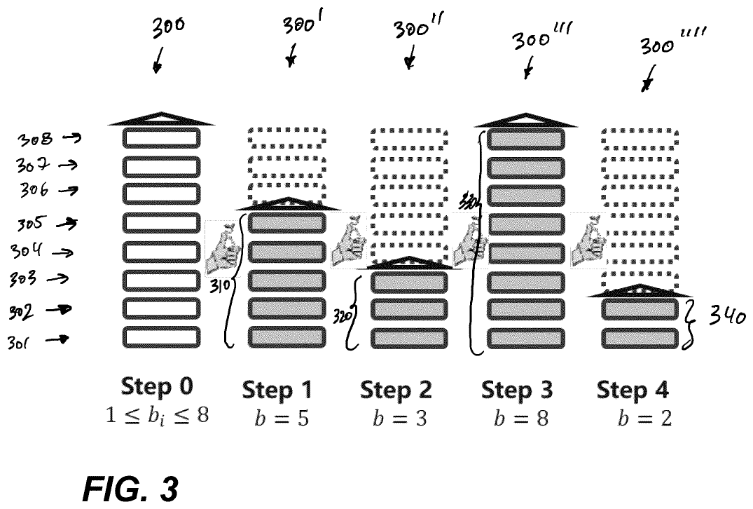

With reference to FIG. 3, there is depicted a plurality of depth-wise training iterations of a model 300. It is contemplated that the model 300 may be implemented in a similar manner to the model 200 shown in FIG. 2. The model 300 comprises intermediate layers 301 to 308 while input and output layer(s) of the model 300 are omitted in FIG. 3 for sake of simplicity only.

During a training step 1, a continuous sequence of intermediate layers 310 of the model 300′ is activated and trained by the processor 110, including five intermediate layers 301-305 (b=5). During a training step 2, a continuous sequence of intermediate layers 320 of the model 300″ is activated and trained by the processor 110, including three intermediate layers 301-303 (b=3). During a training step 3, a continuous sequence of intermediate layers 330 of the model 300″′is activated and trained by the processor 110, including eight intermediate layers 301-308 (b=8). During a training step 4, a continuous sequence of intermediate layers 340 of the model 300″″ is activated and trained by the processor 110, including two intermediate layers 301 and 302 (b=2). It should be noted that in addition to being respective continuous sequences of intermediate layers, the continuous sequences of intermediate layers 310, 320, 330, and 340 at least partially overlap each other. It can be said that the continuous sequences of intermediate layers 310, 320, 330, and 340 are nested continuous sequences of intermediate layers of the model 300.

### Width-Wise Sorted Training

In some embodiments, a last layer of a model (e.g. the classification layer) may be shared between all sub-models. Alternatively, separate classification layers may be used for each sub-model. At each step during the training, a random index is sampled:

$${w}_{i} ∼ {P}_{W} ( \cdot ) where 1 \leq {w}_{i} \leq L \qquad ( 5 )$$

In other embodiments, the processor 110 may be configured to select an index in a non-random manner. The processor 110 may be configured to use at least one of the following functions (i.e., objectives) to update the parameters of the model during training:
a) only update SM_{w}_{ᵢ} in accordance with the following function:

$${min}_{{θ}_{i}} ℒ {=}^{Δ} CE ( y , {SM}_{{w}_{i}} ( x ; {θ}_{i} ) ) \qquad ( 6 )$$

b) sample a random index for the width of the model and train the sub-models from SM_{w1} to SM_{w}_{ᵢ}

$${min}_{{U}_{i = 1}^{{b}_{i}} {θ}_{i}} ℒ {=}^{Δ} {\sum }_{j = 1}^{i} CE ( y , {SM}_{{w}_{j}} ( x ; {θ}_{i} ) ) \qquad ( 7 )$$

Additionally or alternatively, the processor 110 may be configured to use the following function (i.e., objective) to update the parameters of all sub-models (from SM_{w1} to SM_{w}_{_{L}} of a given model during a given training iteration:

$${min}_{{U}_{j = 1}^{{w}_{i}} {θ}_{i}} ℒ {=}^{Δ} {\sum }_{i = 1}^{L} CE ( y , {SM}_{{w}_{j}} ( x ; {θ}_{i} ) ) \qquad ( 8 )$$

### Depth-Wise and Width-Wise Sorted Training

In some embodiments, a last layer of a model (e.g. the classification layer) may be shared between all sub-models. Alternatively, separate classification layers may be used for each sub-model.

At each time-step during training, the processor 110 may be configured to sample a random index for layers of the model (bᵢ˜P_{B}(.) where 1≤bᵢ≤L) and to sample a random index for the width of the model (wᵢ˜P_{W}(.) where 1≤wᵢ≤L). In other embodiments, one or both indexes may be determined by the processor 110 in a non-random manner.

The processor 110 may be configured to use at least one of the following functions (i.e., objectives) to update the parameters of the model during training:
a) only train a selected sub-model SM_{b}_{_{i,}}_{w}_{ᵢ}:

$${min}_{{θ}_{i}} ℒ {=}^{Δ} CE ( y , {SM}_{{b}_{i} , {w}_{i}} ( x ; {θ}_{i} ) ) \qquad ( 9 )$$

b) train the sub-models SM_{1,w}_{ᵢ} to SM_{b}_{_{i,}}_{w}_{ᵢ}:

$${min}_{{U}_{i = 1}^{{b}_{i}} {θ}_{i}} ℒ {=}^{Δ} {\sum }_{i = 1}^{{b}_{i}} CE ( y , {SM}_{i , {w}_{i}} ( x ; {θ}_{i} ) ) \qquad ( 10 )$$

c) train the sub-models SM_{1,w}_{ᵢ} to SM_{L,W}_{ᵢ}

$${min}_{{U}_{i = 1}^{L} {θ}_{i}} ℒ {=}^{Δ} {\sum }_{i = 1}^{L} CE ( y , {SM}_{i , {w}_{i}} ( x ; {θ}_{i} ) ) \qquad ( 11 )$$

In some embodiments of the present technology, the processor 110 may be configured to execute one or more operations in accordance with the algorithm 1 summarized below:

Algorithm 1 SortedNets:

```
Require:
  d =Range[dₘᵢₙ,dₘₐₓ]; i: the number of train-
  ing iterations; g_{acc}: Gradient Accumulation
  Steps P_{B}: probability distribution function for
  sub-model selection; X ∈ [symbol] : all input fea-
  tures; η: Learning Rate, [symbol] : Dynamic Loss;
  W ∈ [symbol]
  while t < i do:
    Forward:
    // sample a specific sub-model
    b ~ P_{B}(d)
    // truncate weight matrix. choose the top b
  nodes
    W_{↓b} = W[:b,:]
    // calculate the output using the truncated
  weights
    h = W_{↓b}X
    Backward:
    if i mod g_{acc} == 0 then
      // update the parameters
      W ← W − ηW [symbol]
    end if
  end while
```

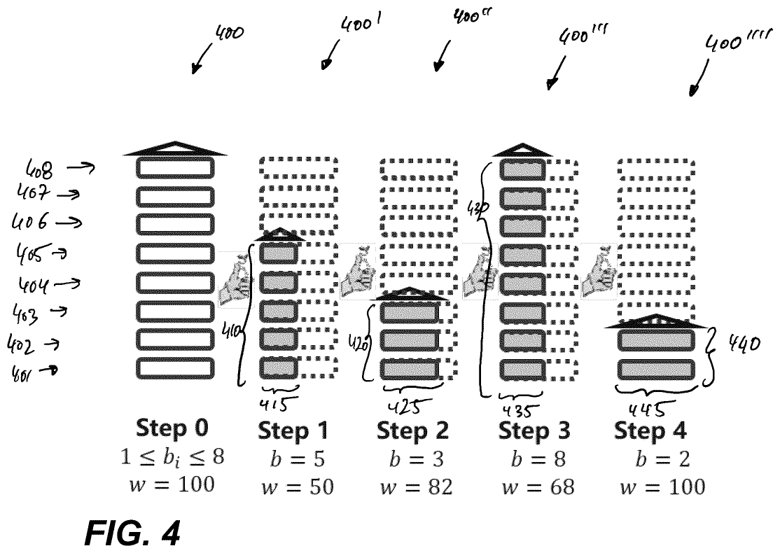

With reference to FIG. 4, there is depicted a plurality of depth-width-wise training iterations of a model 400. It is contemplated that the model 400 may be implemented in a similar manner to the model 200 shown in FIG. 2. The model 400 comprises intermediate layers 401 to 408 while input and output layer(s) of the model 400 are omitted in FIG. 4 for sake of simplicity only.

During a training step 1, 50% (w=50) of the width of a continuous sequence of intermediate layers 410 of the model 400′ is activated and trained by the processor 110, including five intermediate layers 401-405 (b=5). During a training step 2, 85% (w=82) of the width of a continuous sequence of intermediate layers 420 of the model 400″ is activated and trained by the processor 110, including three intermediate layers 401-403 (b=3). During a training step 3, 68% (w=68) of the width of a continuous sequence of intermediate layers 430 of the model 400″′ is activated and trained by the processor 110, including eight intermediate layers 401-408 (b=8). During a training step 4, 100% (w=100) of the width of a continuous sequence of intermediate layers 440 of the model 400″″ is activated and trained by the processor 110, including two intermediate layers 401 and 402 (b=2). It should be noted that in addition to being respective continuous sequences of intermediate layers, the continuous sequences of intermediate layers 410. 420, 430, and 440 at least partially overlap each other in terms of depth and width. It can be said that the continuous sequences of intermediate layers 410, 420, 430, and 440 are nested continuous sequences of intermediate layers of the model 400.

In at least some embodiments of the present technology, there is provided methods and processors for training neural networks in a manner that allows preserving modularity of a given neural network. It is contemplated that a given neural network may be trained in at least one of a layer depth and layer width. In comparison to conventional training techniques, instead of training the entire model, the processor 110 may be configured to train sub-models that are also functional and have a comparable performance to the performance of the main model. In contrast to nested dropout technique, where order is provided to data representations, the processor 110 may be configured to select sequences of layers and/or blocks as respective sub-models of the main model.

### Computer-Implemented Method

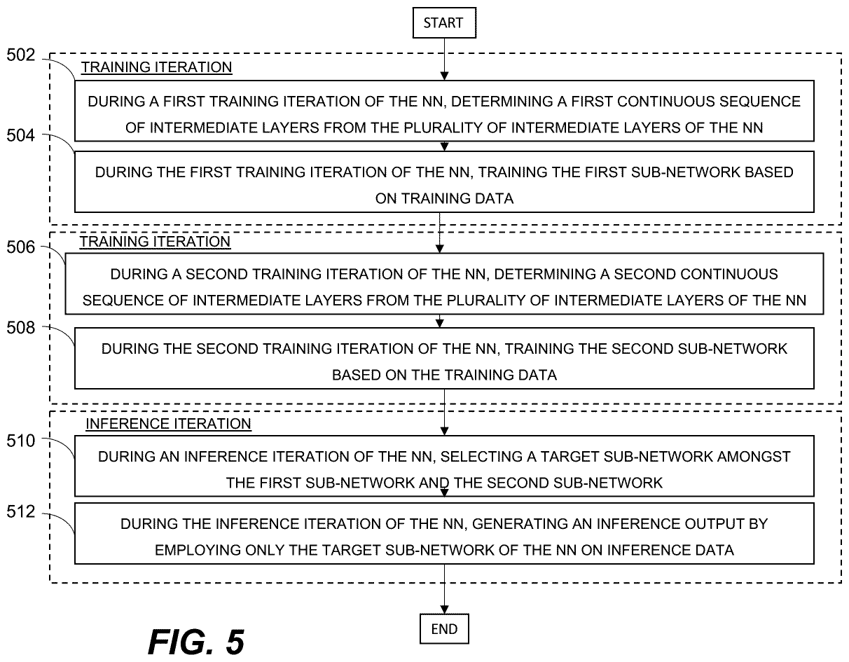

In some embodiments of the present technology, the processor 110 is configured to execute a method 500 of using a Neural Network (NN), the NN comprising an input layer, an output layer, and a plurality of intermediate layers. A scheme-block illustration of operations of the method 500 is depicted in FIG. 5. It is contemplated that the method 500 can be executed by an electronic device implemented similarly to what has been described above with reference to FIG. 1. In some embodiments, one or more steps of the method 500 may be executed by more than one physical processors. For example, more than one physical processors may be communicatively coupled over a network for performing one or more steps in a distributed manner. It is therefore contemplated that one or more steps from the method xxx may be executed by distinct electronic devices, without departing from the scope of the present technology.

### Step 502: During a First Training Iteration of the NN, Determining a First Continuous Sequence of Intermediate Layers From the Plurality of Intermediate Layers of the NN

The method 500 starts with, at operation 502 during a first training iteration of the NN, determining a first continuous sequence of intermediate layers from the plurality of intermediate layers of the NN. The input layer, the first continuous sequence of intermediate layers, and the output layer form a first sub-network of the NN.

In some implementations, the plurality of intermediate layers is a plurality of architectural blocks of the NN, a given one of the plurality of architectural blocks including a sub-set of intermediate layers for generating an output of the given one of the plurality of architectural blocks. For example and without limitation, the plurality of architectural blocks may include at least one of a convolutional block with at least one convolutional layer, a pooling block with at least one pooling layer, a fully connected block with at least one fully-connected layer, a residual block with at least one skip connection, a batch normalization block with at least one batch normalization layer, a recurrent block with at least one recurrence mechanism, an attention block with at least one self-attention mechanism and an activation block with at least one activation layer.

### Step 504: During the First Training Iteration of the NN, Training The First Sub-Network Based on Training Data

The method 500 continues with training, at operation 504 during a first training iteration of the NN, the first sub-network based on training data.

### Step 506: During a Second Training Iteration of the NN, Determining a Second Continuous Sequence of Intermediate Layers From the Plurality of Intermediate Layers of the NN

The method 500 continues with determining, at operation 506 during a second training iteration of the NN, a second continuous sequence of intermediate layers from the plurality of intermediate layers of the NN, the input layer, the second continuous sequence of intermediate layers, and the output layer forming a second sub-network of the NN. In this implementation, the second continuous sequence of intermediate layers is different from the first sequence of continuous layers, the second continuous sequence of intermediate layers at least partially overlapping the first sequence of continuous layers.

In some implementations, the output layer may be at least two output layers, and wherein the output layer of the first sub-network is a first one from the at least two output layers, and the output layer of the second sub-network is a second one from the at least two output layers, the first and second one of the at least two output layers being different output layers.

### Step 508: During the Second Training Iteration of the NN, Training the Second Sub-Network Based on the Training Data

The method 500 continues with training, at operation 508 during a second training iteration of the NN, the second sub-network based on the training data.

### Step 510: During an Inference Iteration of the NN, Selecting a Target Sub-Network Amongst the First Sub-Network and the Second Sub-Network

The method 500 continues with selecting, at operation 510 and during an inference iteration of the NN, a target sub-network amongst the first sub-network and the second sub-network. In some implementations, the selecting the target sub-network includes comparing at least one of a first accuracy parameter of the first sub-network and a second accuracy parameter of the second sub-network, a first latency parameter of the first sub-network and a second latency parameter of the second sub-network, and a first importance parameter of the first sub-network and a second importance parameter of the second sub-network.

### Step 512: During the Inference Iteration of the NN, Generating an Inference Output by Employing Only the Target Sub-Network of the NN on Inference Data

The method 500 continues with generating, at operation 512 and during an inference iteration of the NN, an inference output by employing only the target sub-network of the NN on inference data for reducing computational resources of the at least one processor for generating the inference output.

In some implementations, the method further includes, during the first training iteration, determining a first depth index indicative of a first depth of the first continuous sequence of intermediate layers in the NN. The determining the first continuous sequence of intermediate layers may includes determining a continuous sequence of intermediate layers that is most adjacent to the input layer of the NN and which includes a total number of layers equal to the first depth index. In these implementations, the method 500 may further include, during the second training iteration, determining a second depth index indicative of a second depth of the second continuous sequence of intermediate layers in the NN, the second depth index being different from the first depth index. The determining the second continuous sequence of intermediate layers may include determining an other continuous sequence of intermediate layers that is most adjacent to the input layer of the NN and which includes a total number of layers equal to the second depth index.

For example and without limitation, the determining the first depth index may include randomly determining the first depth index from an interval of depth indexes, and the determining the second depth index includes randomly determining the second depth index from the interval of depth indexes, the interval of depth indexes having been pre-determined based on a depth of the NN.

In the same or alternative implementations, the method 500 further includes, during the first training iteration, determining a first width index for the first continuous sequence of intermediate layers indicative a first partial width of the first continuous sequence of intermediate layers to be trained during the first training iteration. The training the first sub-network includes training only the first partial width of the first continuous sequence of intermediate layers based on the training data. During the second training iteration, the method 500 may further include determining a second width index for the second continuous sequence of intermediate layers indicative a second partial width of the second continuous sequence of intermediate layers to be trained during the second training iteration, the second width index being different from the first width index. The training the second sub-network includes training only the second partial width of the second continuous sequence of intermediate layers based on the training data.

For example and without limitation, the determining the first width index may include randomly determining the first width index from an interval of width indexes, and the determining the second width index includes randomly determining the second width index from the interval of width indexes, the interval of width indexes having been pre-determined based on a width of the plurality of intermediate layers of the NN.

It will be appreciated that at least some of the operations of the method 500 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of using a Neural Network (NN), the NN comprising an input layer, an output layer, and a plurality of intermediate layers, the method executable by at least one processor and comprising:
during a first training iteration of the NN:
determining a first continuous sequence of intermediate layers from the plurality of intermediate layers of the NN,
the input layer, the first continuous sequence of intermediate layers, and the output layer forming a first sub-network of the NN;
training the first sub-network based on training data;
during a second training iteration of the NN:
determining a second continuous sequence of intermediate layers from the plurality of intermediate layers of the NN,
the input layer, the second continuous sequence of intermediate layers, and the output layer forming a second sub-network of the NN,
the second continuous sequence of intermediate layers being different from the first sequence of continuous layers, the second continuous sequence of intermediate layers at least partially overlapping the first sequence of continuous layers;
training the second sub-network based on the training data;
during an inference iteration of the NN:
selecting a target sub-network amongst the first sub-network and the second sub-network; and
generating an inference output by employing only the target sub-network of the NN on inference data for reducing computational resources of the at least one processor for generating the inference output.

2. The method of claim 1, wherein the method further comprises:
during the first training iteration:
determining a first depth index indicative of a first depth of the first continuous sequence of intermediate layers in the NN,
and wherein the determining the first continuous sequence of intermediate layers includes:
determining a continuous sequence of intermediate layers that is most adjacent to the input layer of the NN and which includes a total number of layers equal to the first depth index;
and wherein:
during the second training iteration:
determining a second depth index indicative of a second depth of the second continuous sequence of intermediate layers in the NN, the second depth index being different from the first depth index,
and wherein the determining the second continuous sequence of intermediate layers includes:
determining an other continuous sequence of intermediate layers that is most adjacent to the input layer of the NN and which includes a total number of layers equal to the second depth index.

3. The method of claim 2, wherein the determining the first depth index includes randomly determining the first depth index from an interval of depth indexes, and the determining the second depth index includes randomly determining the second depth index from the interval of depth indexes, the interval of depth indexes having been pre-determined based on a depth of the NN.

4. The method of claim 1, wherein the method further comprises:
during the first training iteration:
determining a first width index for the first continuous sequence of intermediate layers indicative a first partial width of the first continuous sequence of intermediate layers to be trained during the first training iteration,
and wherein the training the first sub-network includes:
training only the first partial width of the first continuous sequence of intermediate layers based on the training data,
and wherein:
during the second training iteration:
determining a second width index for the second continuous sequence of intermediate layers indicative a second partial width of the second continuous sequence of intermediate layers to be trained during the second training iteration, the second width index being different from the first width index,
the training the second sub-network includes:
training only the second partial width of the second continuous sequence of intermediate layers based on the training data.

5. The method of claim 4, wherein the determining the first width index includes randomly determining the first width index from an interval of width indexes, and the determining the second width index includes randomly determining the second width index from the interval of width indexes, the interval of width indexes having been pre-determined based on a width of the plurality of intermediate layers of the NN.

6. The method of claim 1, wherein the selecting the target sub-network comprises comparing at least one of:
(i) a first accuracy parameter of the first sub-network and a second accuracy parameter of the second sub-network,
(ii) a first latency parameter of the first sub-network and a second latency parameter of the second sub-network, and
(iii) a first importance parameter of the first sub-network and a second importance parameter of the second sub-network.

7. The method of claim 1, wherein the plurality of intermediate layers is a plurality of architectural blocks of the NN, a given one of the plurality of architectural blocks including a sub-set of intermediate layers for generating an output of the given one of the plurality of architectural blocks.

8. The method of claim 7, wherein the plurality of architectural blocks include at least one of:
(i) a convolutional block with at least one convolutional layer;
(ii) a pooling block with at least one pooling layer;
(iii) a fully connected block with at least one fully-connected layer;
(iv) a residual block with at least one skip connection;
(v) a batch normalization block with at least one batch normalization layer;
(vi) a recurrent block with at least one recurrence mechanism;
(vii) an attention block with at least one self-attention mechanism; and
(viii) an activation block with at least one activation layer.

9. The method of claim 1, wherein the output layer is at least two output layers, and wherein the output layer of the first sub-network is a first one from the at least two output layers, and the output layer of the second sub-network is a second one from the at least two output layers, the first and second one of the at least two output layers being different output layers.

10. A system for using a Neural Network (NN), the NN comprising an input layer, an output layer, and a plurality of intermediate layers, the system comprising a controller and a memory storing a plurality of executable instructions which, when executed by the controller, cause the system to:
during a first training iteration of the NN:
determine a first continuous sequence of intermediate layers from the plurality of intermediate layers of the NN,
the input layer, the first continuous sequence of intermediate layers, and the output layer forming a first sub-network of the NN;
train the first sub-network based on training data;
during a second training iteration of the NN:
determine a second continuous sequence of intermediate layers from the plurality of intermediate layers of the NN,
the input layer, the second continuous sequence of intermediate layers, and the output layer forming a second sub-network of the NN,
the second continuous sequence of intermediate layers being different from the first sequence of continuous layers, the second continuous sequence of intermediate layers at least partially overlapping the first sequence of continuous layers;
train the second sub-network based on the training data;
during an inference iteration of the NN:
select a target sub-network amongst the first sub-network and the second sub-network; and
generate an inference output by employing only the target sub-network of the NN on inference data for reducing computational resources of the at least one processor for generating the inference output.

11. The system of claim 10, wherein the system is further configured to:
during the first training iteration:
determine a first depth index indicative of a first depth of the first continuous sequence of intermediate layers in the NN,
and wherein the determining the first continuous sequence of intermediate layers includes:
determining a continuous sequence of intermediate layers that is most adjacent to the input layer of the NN and which includes a total number of layers equal to the first depth index;
and wherein:
during the second training iteration:
determine a second depth index indicative of a second depth of the second continuous sequence of intermediate layers in the NN, the second depth index being different from the first depth index,
and wherein the determining the second continuous sequence of intermediate layers includes:
determining an other continuous sequence of intermediate layers that is most adjacent to the input layer of the NN and which includes a total number of layers equal to the second depth index.

12. The system of claim 11, wherein the determining the first depth index includes randomly determining the first depth index from an interval of depth indexes, and the determining the second depth index includes randomly determining the second depth index from the interval of depth indexes, the interval of depth indexes having been pre-determined based on a depth of the NN.

13. The system of claim 10, wherein the system is further configured to:
during the first training iteration:
determine a first width index for the first continuous sequence of intermediate layers indicative a first partial width of the first continuous sequence of intermediate layers to be trained during the first training iteration,
and wherein the training the first sub-network includes:
training only the first partial width of the first continuous sequence of intermediate layers based on the training data,
and wherein:
during the second training iteration:
determine a second width index for the second continuous sequence of intermediate layers indicative a second partial width of the second continuous sequence of intermediate layers to be trained during the second training iteration, the second width index being different from the first width index,
the training the second sub-network including:
training only the second partial width of the second continuous sequence of intermediate layers based on the training data.

14. The system of claim 13, wherein the determining the first width index includes randomly determining the first width index from an interval of width indexes, and the determining the second width index includes randomly determining the second width index from the interval of width indexes, the interval of width indexes having been pre-determined based on a width of the plurality of intermediate layers of the NN.

15. The system of claim 10, wherein the system is configured to, upon selecting the target sub-network, compare at least one of:
(i) a first accuracy parameter of the first sub-network and a second accuracy parameter of the second sub-network,
(ii) a first latency parameter of the first sub-network and a second latency parameter of the second sub-network, and
(iii) a first importance parameter of the first sub-network and a second importance parameter of the second sub-network.

16. The system of claim 10, wherein the plurality of intermediate layers is a plurality of architectural blocks of the NN, a given one of the plurality of architectural blocks including a sub-set of intermediate layers for generating an output of the given one of the plurality of architectural blocks.

17. The system of claim 16, wherein the plurality of architectural blocks include at least one of:
(i) a convolutional block with at least one convolutional layer;
(ii) a pooling block with at least one pooling layer;
(iii) a fully connected block with at least one fully-connected layer;
(iv) a residual block with at least one skip connection;
(v) a batch normalization block with at least one batch normalization layer;
(vi) a recurrent block with at least one recurrence mechanism;
(vii) an attention block with at least one self-attention mechanism; and
(viii) an activation block with at least one activation layer.

18. The system of claim 10, wherein the output layer is at least two output layers, and wherein the output layer of the first sub-network is a first one from the at least two output layers, and the output layer of the second sub-network is a second one from the at least two output layers, the first and second one of the at least two output layers being different output layers.
